(19) United States
(12) Patent Application Publication
(10) Pub. No.: US 2010/0106797 A1
(43) Pub. Date: Apr. 29, 2010

(54) METHODS AND APPARATUS FOR HYBRID BROADCAST AND PEER-TO-PEER NETWORK USING COOPERATIVE MIMO

(75) Inventor: Nagendra Nagaraja, Bangalore (IN)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/411,947

(22) Filed: Mar. 26, 2009

Related U.S. Application Data
(60) Provisional application No. 61/107,859, filed on Oct. 23, 2008.

(51) Int. Cl. G06F 15/16

(52) U.S. Cl. 709/217; 375/260

(57) ABSTRACT

A method for obtaining a desired broadcast channel is described. A broadcast channel may be received from a broadcast network. The received broadcast channel may be sent to at least one peer-to-peer network peer over a peer-to-peer network. A desired broadcast channel may be received from at least one peer-to-peer network peer over the peer-to-peer network. The desired broadcast channel may be played.

### RELATED APPLICATIONS

This application is related to and claims priority from U.S. Provisional Patent Application Ser. No. 61/107,859 filed Oct. 23, 2008 for “Co-Operative MIMO for Hybrid Broadcast and P2P Network for HD video.”

### TECHNICAL FIELD

The present disclosure relates generally to communication systems. More specifically, the present disclosure relates to methods and apparatus for hybrid broadcast and peer-to-peer network using cooperative MIMO.

### BACKGROUND

Wireless communication systems are widely deployed to provide various types of communication content such as voice, video, data, and so on. These systems may be multiple-access systems capable of supporting simultaneous communication of multiple terminals with one or more base stations.

As used herein, the term “mobile station” refers to an electronic device that may be used for voice and/or data communication over a wireless communication network. Examples of mobile stations include cellular phones, personal digital assistants (PDAs), handheld devices, wireless modems, laptop computers, personal computers, etc. A mobile station may alternatively be referred to as an access terminal, a mobile terminal, a subscriber station, a remote station, a user terminal, a terminal, a subscriber unit, user equipment, etc.

A wireless communication network may provide communication for a number of mobile stations, each of which may be serviced by a base station. A base station may alternatively be referred to as an access point, a Node B, or some other terminology.

A mobile station may communicate with one or more base stations via transmissions on the uplink and the downlink. The uplink (or reverse link) refers to the communication link from the mobile station to the base station, and the downlink (or forward link) refers to the communication link from the base station to the mobile station.

Communication between a terminal in a wireless system (e.g., a multiple-access system) and a base station is effected through transmissions over a wireless link comprised of a forward link and a reverse link. Such communication link may be established via a single-input and single-output (SISO), multiple-input and single-output (MISO), or a multiple-input and multiple-output (MIMO) system. A MIMO system consists of transmitter(s) and receiver(s) equipped, respectively, with multiple (M_{T}) transmit antennas and multiple (M_{R}) receive antennas for data transmission. SISO and MISO systems are particular instances of a MIMO system. The MIMO system can provide improved performance (e.g. higher throughput, greater capacity, or improved reliability) if the additional dimensionalities created by the multiple transmit and receive antennas are utilized.

Broadcast networks have been used to deliver content such as high definition television to mobile devices. However, broadcast networks are inherently used for long range applications, thus increasing the channel switching times and the overall energy consumption for receiving the content. Peer-to-peer networks are inherently used for short range applications.

Benefits may be realized by improved systems and methods related to the operation of wireless communication networks implementing cooperative MIMO in a hybrid network employing both a broadcast network and a peer-to-peer network.

### BRIEF DESCRIPTION OF THE DRAWINGS

FIG. 1 shows a wireless communication system with multiple wireless devices;

FIG. 2 shows a block diagram of a broadcast network;

FIG. 3 shows a block diagram of a peer-to-peer network;

FIG. 4 is a flow diagram illustrating a method for registration with a peer-to-peer network by a mobile device;

FIG. 4A illustrates means-plus-function blocks corresponding to the method of FIG. 4;

FIG. 5 is a flow diagram illustrating a method for registering with a peer-to-peer network to receive broadcast channels using cooperative MIMO;

FIG. 5A illustrates means-plus-function blocks corresponding to the method of FIG. 5;

FIG. 6 is a block diagram illustrating some of the components of a mobile device for use in the present methods and apparatus;

FIG. 7 is a flow diagram illustrating a method for a hybrid peer-to-peer and broadcast HDTV network;

FIG. 7A illustrates means-plus-function blocks corresponding to the method of FIG. 7;

FIG. 8 is a flow diagram illustrating a method for receiving and displaying HDTV channels in a hybrid peer-to-peer and broadcast network;

FIG. 8A illustrates means-plus-function blocks corresponding to the method of FIG. 8;

FIG. 9 is a block diagram illustrating the architecture of a mobile device which supports both a broadcast network and a peer-to-peer network on the same device;

FIG. 10 is a block diagram illustrating the functionality of a lookup table on a mobile device;

FIG. 11 is a block diagram illustrating spatial multiplexing MIMO;

FIG. 12 is a block diagram illustrating diversity mapping MIMO; and

FIG. 13 illustrates certain components that may be included within a wireless device that is configured in accordance with the present disclosure.

### DETAILED DESCRIPTION

A method for obtaining a desired broadcast channel is disclosed. A broadcast channel is received from a broadcast network. The received broadcast channel is sent to at least one peer-to-peer network peer over a peer-to-peer network. A desired broadcast channel is received from at least one peer-to-peer network peer over the peer-to-peer network. The desired broadcast channel is played.

Receiving a broadcast channel may further include receiving a plurality of broadcast channels from the broadcast network. The received broadcast channel may be decoded using a lookup table. The received broadcast channel from a broadcast network may be modulated using cooperative multiple input multiple output (MIMO). A channel address may be translated for a received broadcast channel to a peer-to-peer network channel using a lookup table.

A receive code may be used to receive only part of a broadcast transmission from the broadcast network. The broadcast transmission may include one or more broadcast channels. A broadcast channel may be a high definition television (HDTV) channel.

The method may also include registering with a peer-to-peer network to receive broadcast channels. The method may be performed by a mobile device. Registering may include several actions. One or more peer-to-peer networks within reach of the mobile device may be detected. The mobile device may register with a peer-to-peer network within reach of the mobile device. Available channel information may be requested for the peer-to-peer network that the mobile device is registered with. The available channel information for the peer-to-peer network that the mobile device is registered with may be received. The mobile device may determine a broadcast channel to receive from a broadcast network.

The lookup table may be updated when a new peer is added to the peer-to-peer network. In addition, the lookup table may be updated when a peer is removed from the peer-to-peer network.

Sending the received broadcast channel may further include sending the received broadcast channel to a plurality of peer-to-peer network peers over the peer-to-peer network. Receiving the desired broadcast channel may further include receiving the desired broadcast channel from a plurality of peer-to-peer network peers. Playing the desired broadcast channel may include displaying the desired broadcast channel on a high definition television (HDTV) video display. A peer of the peer-to-peer network may be cooperated with to enhance the signal quality of the received broadcast channel.

A wireless device configured for operation in a hybrid broadcast and peer-to-peer network is disclosed. The wireless device includes a processor and memory in electronic communication with the processor. Executable instructions are stored in the memory. A broadcast channel is received from a broadcast network. The received broadcast channel is sent to at least one peer-to-peer network peer over a peer-to-peer network. A desired broadcast channel is received from at least one peer-to-peer network peer over the peer-to-peer network. The desired broadcast channel is played.

The wireless device may be a modem. Furthermore, the wireless device may be a modem capable of communicating concurrently with a broadcast network and a peer-to-peer network.

A wireless device configured for operation in a hybrid broadcast and peer-to-peer network is disclosed. The wireless device may include means for receiving a broadcast channel from a broadcast network. The wireless device may also include means for sending the received broadcast channel to at least one peer-to-peer network peer over a peer-to-peer network. The wireless device may also include means for receiving a desired broadcast channel from at least one peer-to-peer network peer over the peer-to-peer network. The wireless device may also include means for playing the desired broadcast channel.

A computer-program product for a wireless device configured for operation in a hybrid broadcast and peer-to-peer network is disclosed. The computer-program product may comprise a computer-readable medium having instructions thereon. The instructions may include code for receiving a broadcast channel from a broadcast network. The instructions may also include code for sending the received broadcast channel to at least one peer-to-peer network peer over a peer-to-peer network. The instructions may also include code for receiving a desired broadcast channel from at least one peer-to-peer network peer over the peer-to-peer network. The instructions may also include code for playing the desired broadcast channel.

A wireless communication system is also disclosed. The wireless communication system may include a broadcast network. The broadcast network may include at least one broadcast transmitter and at least two receiving mobile devices. The broadcast transmitter may transmit a broadcast transmission to at least one of the receiving mobile devices. The wireless communication system may also include a peer-to-peer network. The peer-to-peer network may include the at least two receiving mobile devices. At least one of the receiving mobile devices may receive the broadcast transmission from the broadcast transmitter. The receiving mobile device that receives the broadcast transmission may share the broadcast transmission with other mobile devices within the peer-to-peer network.

Each mobile device in the peer-to-peer network may act as a receiving antenna in a virtual multiple input multiple output (MIMO) receiver. Each mobile device in the peer-to-peer network may cooperate to decode the broadcast transmission. The broadcast transmission may be a high definition television (HDTV) channel.

The at least two receiving mobile devices may decode the received broadcast transmission using a lookup table. The lookup table may be updated when additional receiving mobile devices are added to the peer-to-peer network.

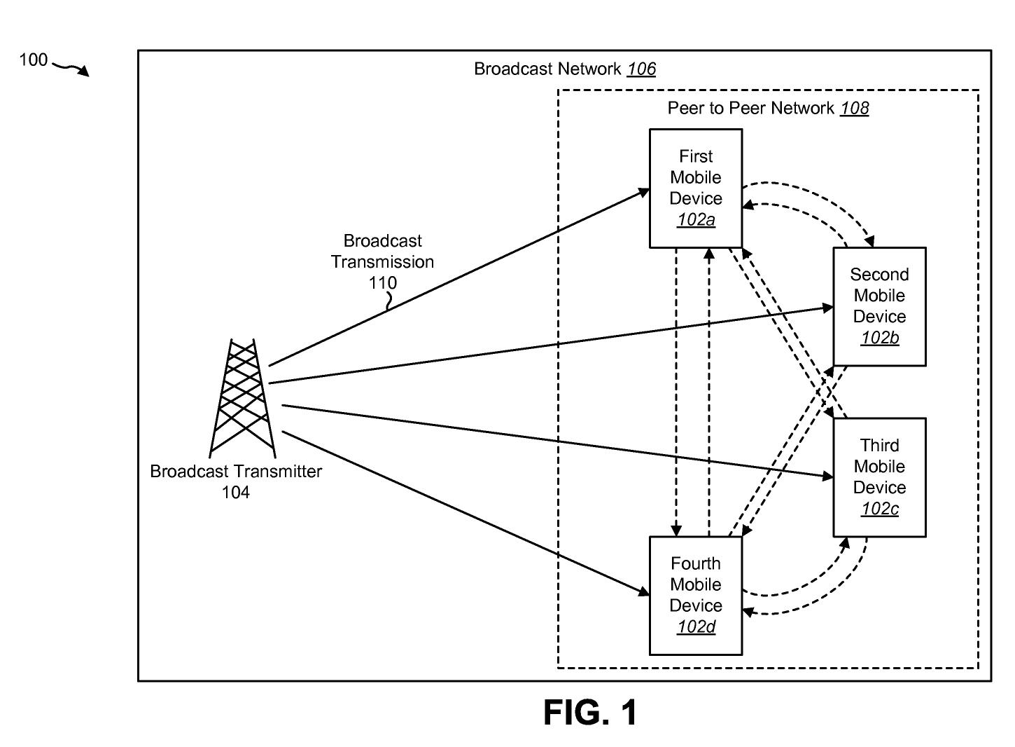

FIG. 1 shows a wireless communication system 100 with multiple wireless devices. A wireless device may be a base station, a mobile device, a relay node, or the like. In one configuration, the wireless device may be a modem. A base station is a station that communicates with one or more mobile devices 102. A base station may also be referred to as, and may include some or all of the functionality of, an access point, a broadcast transmitter, a Node B, an evolved Node B, etc. Within a broadcast network, a base station may be referred to as a broadcast transmitter 104. Each base station provides communication coverage for a particular geographic area. The term “cell” can refer to a base station and/or its coverage area depending on the context in which the term is used.

A mobile device 102 may also be referred to as, and may include some or all of the functionality of, a terminal, an access terminal, a user equipment, a subscriber unit, a station, etc. A mobile device 102 may be a cellular phone, a personal digital assistant (PDA), a wireless device, a wireless modem, a handheld device, a laptop computer, etc. A mobile device 102 may communicate with zero, one, or multiple base stations on the downlink (DL) and/or uplink (UL) at any given moment. The downlink (or forward link) refers to the communication link from the base stations to the mobile devices, and the uplink (or reverse link) refers to the communication link from the mobile devices 102 to the base stations.

The wireless communication system 100 may include a broadcast network 106. The broadcast network 106 may include one or more broadcast transmitters 104 and one or more mobile devices 102. The mobile devices 102 may be part of a peer-to-peer network 108 within the broadcast network 106. In other words, the mobile devices 102 may be capable of communicating concurrently with both a broadcast network 106 and a peer-to-peer network 108. A mobile device 102 capable of communicating concurrently with multiple networks may be referred to as a hybrid mobile device 102. For example, the mobile device 102 may be a hybrid modem capable of communicating concurrently with both the broadcast network 106 and the peer-to-peer network 108. The one or more broadcast transmitters 104 may broadcast data to the mobile devices 102 over a broadcast transmission 110. For example, the one or more broadcast transmitters 104 may deliver HDTV (high-definition television) channels to the mobile devices 102. The one or more broadcast transmitters 104 may deliver data to the mobile devices 102 using one or more access technologies. For example, a broadcast transmitter 104 may deliver data to the mobile devices 102 using MediaFLO, Digital Video Broadcasting—Handheld (DVB-H), Digital Multimedia Broadcasting (DMB), etc.

MediaFLO may support a number of channels, of which a user requires one channel at a time. In MediaFLO, a principle of time-slicing may be used and channels may be assigned to an individual carrier. MIMO may be used for DVB-H and MediaFLO. DVB-H and MediaFLO may support data rates of approximately 10 megabits per second (Mbps). The data rates required for the best pictures in an HDTV channel are 25-27 Mbps.

The peer-to-peer network 108 may be a mesh-based network. For example, the peer-to-peer network 108 may use a mesh-based access technology such as Ultra-wideband (UWB), Qualcomm Personal Area Network Low power technology (PEANUT), 802.11n, etc. A mesh-based network may use orthogonal frequency division multiplexing (OFDM) for the physical layer. The peer-to-peer network 108 may be a short range, low power, and high bandwidth network.

The wireless communication system 100 may utilize cooperative MIMO. The term “multiple-input and multiple-output” (MIMO) refers to the use of multiple antennas at both the transmitter and receiver to improve communication performance. At the transmitter, each portion of a data stream may be transmitted from a different antenna. At the receiver, the different portions of the data stream may be received by different antennas and then combined. The terms “data stream” and “layer” are used interchangeably herein. In cooperative MIMO, the performance of a wireless network may be improved by applying MIMO techniques to a group of mobile devices or receive node clusters. For example, cooperative MIMO may improve the signal quality and network capacity of the broadcast network 106, thereby improving efficiency for the broadcast network 106.

In cooperative MIMO, each mobile device 102 of a receive node cluster may receive MIMO modulated signals. Thus, the peer-to-peer network 108 may collectively act as a virtual MIMO, where each node antenna for each mobile device 102 acts as a MIMO receiving antenna. Each mobile device 102 of a peer-to-peer network 108 may be referred to as a receive node. A broadcast transmitter 104 may also be referred to as a source. Each peer-to-peer network 108 may be enabled by a single source or by multiple sources. Multiple sources means a peer-to-peer network 108 is receiving a data stream from more than one broadcast transmitter 104.

Each broadcast transmitter 104 may send a modulated MIMO signal to the receiving nodes of the peer-to-peer network 108. For example, a broadcast transmitter 104 may send a broadcast transmission 110 to a first mobile device 102a. The first mobile device 102a may then share the received broadcast transmission 110 with the mobile devices 102 within the peer-to-peer network 108. For example, the first mobile device 102a may cooperate with a second mobile device 102b, a third mobile device 102c, and a fourth mobile device 102d to provide an HDTV channel to an HD (high definition) video receiver.

A broadcast network 106 in combination with a peer-to-peer network 108 using cooperative MIMO may increase the overall capacity of the broadcast network 106. The channel switching times for mobile devices 102 may be significantly lowered. Furthermore, the energy consumption for receiving broadcast HD video may be reduced. The use of cooperative MIMO may also act as a platform for sharing multiple broadcasts among peers. A broadcast network 106 in combination with a peer-to-peer network 108 using cooperative MIMO may be particularly useful in high user-density areas such as business places, airports, markets, apartments, etc.

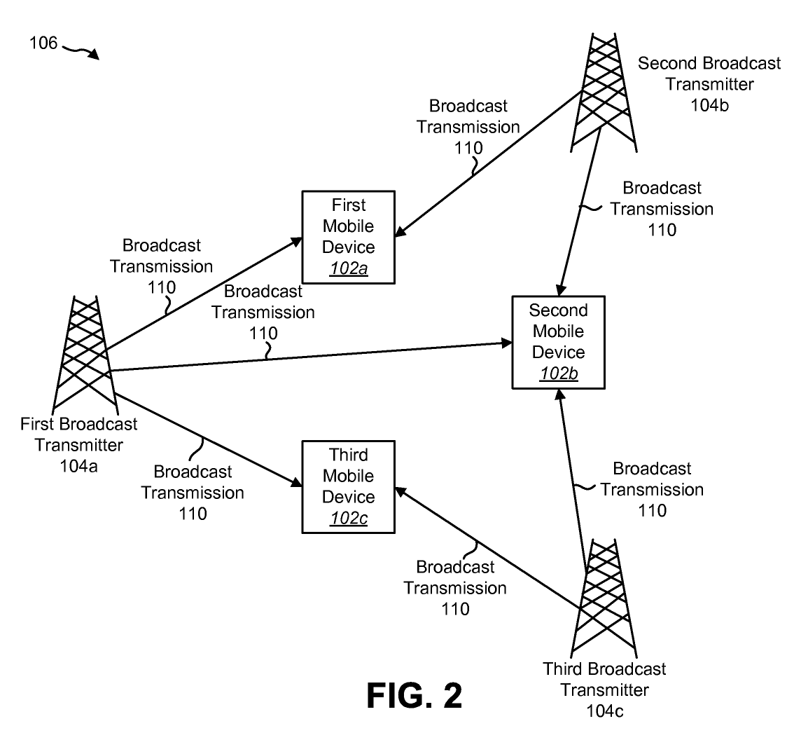

FIG. 2 shows a block diagram of a broadcast network 106. The broadcast network 106 may include one or more broadcast transmitters 104. The broadcast network 106 may also include one or more mobile devices 102. A broadcast transmitter 104 may transmit a broadcast transmission 110 to one or more mobile devices 102. For example, a broadcast transmitter 104 may transmit high definition video broadcasts to one or more mobile devices 102.

A broadcast transmitter 104 may transmit multiple broadcast transmissions 110 to multiple mobile stations 102. For example, a first broadcast transmitter 104a may transmit a broadcast transmission 110 to a first mobile device 102a, a second mobile device 102b, and a third mobile device 102c. Each broadcast transmission 110 may include one or more broadcast channels. Alternatively, each broadcast transmitter 104 may transmit portions of each broadcast channel to one or more mobile devices 102. For example, the first broadcast transmitter 104a may transmit a portion of the first broadcast channel to the first mobile device 102a and a portion of the first broadcast channel to the second mobile device 102b.

A mobile device 102 may receive signal streams from multiple broadcast transmitters 104. For example, the second mobile device 102b may receive a broadcast transmission 110 from the first broadcast transmitter 104a, a second broadcast transmitter 104b, and a third broadcast transmitter 104c.

It may be difficult to deliver a large number of HDTV channels to multiple mobile devices 102 using only the broadcast network 106. The broadcast network 106 is intended to operate over a long range, which may require very high spectral efficiency, complex receivers, and more receive power consumption to decode HDTV channels. Benefits may be realized by combining the use of a broadcast network 106 with a peer-to-peer network 108 using cooperative MIMO. Cooperative MIMO may reduce the energy of each node in a peer-to-peer network 108. The number of channels available to a mobile device 102 may increase if some of the nodes in a peer-to-peer network 108 are in a different broadcast network 106 than the mobile device 102.

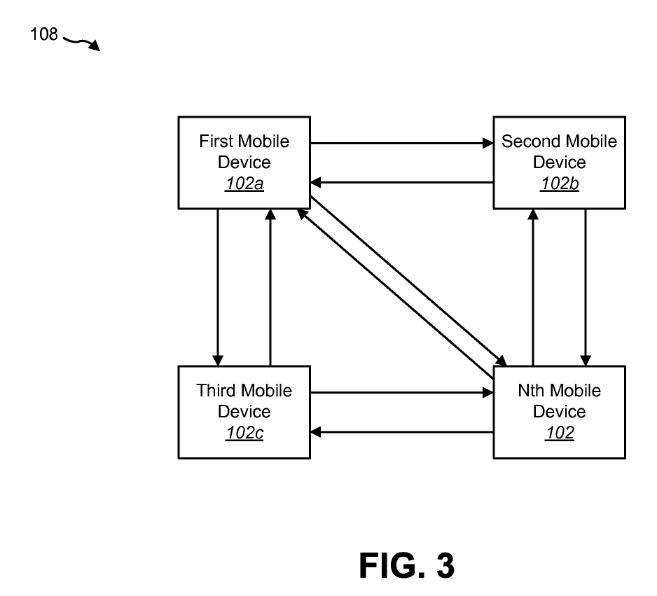

FIG. 3 shows a block diagram of a peer-to-peer network 108. A peer-to-peer network 108 may have a much shorter range than a broadcast network 106. As such, a peer-to-peer network 108 may consume less power for transmission and reception of signal streams. Examples of peer-to-peer networks include Ultra-wideband (UWB), PEANUT, 802.11n, etc. The data rates for a short range peer-to-peer network 108 such as UWB may be around 500 megabits-per-second (Mbps) to 1 gigabit-per-second (Gbps).

The peer-to-peer network 108 may include two or more mobile devices 102. The mobile devices 102 within a peer-to-peer network 108 may be referred to as peers or nodes. Each mobile device 102 may have received a signal stream from one or more broadcast transmitters 104. The members of the peer-to-peer network 108 may subscribe to the same broadcast network 106. As a result, in some configurations the registration process of a mobile device 102 into a peer-to-peer network 108 may depend on the access rights from the broadcast network operator.

Each mobile device 102 within the peer-to-peer network 108 may receive different broadcast channels from one or more broadcast transmitters 104. For example, a first mobile device 102a may receive a first broadcast channel while a second mobile device 102b concurrently receives a second broadcast channel. Alternatively, each mobile device 102 may concurrently receive different portions of each broadcast channel. For example, the first mobile device 102a may receive a portion of the first broadcast channel and a portion of the second broadcast channel concurrent with the second mobile device 102b receiving a different portion of the first broadcast channel and a different portion of the second broadcast channel. The mobile devices 102 may then share the received portions of each broadcast channel, thereby reproducing the original broadcast channel.

The peer-to-peer network 108 may be formed once a user switches on a mobile device 102. In one configuration, the peer-to-peer network 108 may be formed exclusively for high definition television (HDTV) sharing. An arbitration algorithm may determine which mobile device 102 will access which broadcast channel. The arbitration algorithm may be used when a mobile device 102 drops out of the peer-to-peer network 108 or when a new mobile device 102 joins the peer-to-peer network 108. If the arbitration algorithm is used or executed, a new peer-to-peer network 108 may be formed.

Each mobile device 102 within the peer-to-peer network 108 may relay the broadcast channels to all other mobile devices 102 within the peer-to-peer network 108. For example, if the first mobile device 102a is receiving the first broadcast channel from the broadcast network 106, the first mobile device 102a may relay the first broadcast channel to each of the other mobile devices 102 within the peer-to-peer network 108. As another example, if the first mobile device 102a and the second mobile device 102b each receive the first broadcast channel, the first mobile device 102a and the second mobile device 102b may cooperate to enhance the signal quality of the first broadcast channel. The first mobile device 102a and the second mobile device 102b may each send the enhanced signal quality version of the first broadcast channel to the other mobile devices 102 within the peer-to-peer network 108.

A broadcast transmission 110 may be encoded using MIMO such that each channel will be assigned a code at the receiving device (e.g., the mobile device 102 receiving the channel), thereby allowing the mobile devices 102 or peers within the peer-to-peer network 108 to cooperate and enhance the signal quality of the channel. The peers may cooperate to provide a desired channel to an HD video receiver on a mobile device 102. In other words, the peers may act as a virtual MIMO receiver, where each receiver on each mobile device 102 receives only part of the broadcast instead of accessing the entire broadcast directly. Each node within the peer-to-peer network 108 may receive the broadcast channels from the broadcast network 106 at the same time. Each node within the peer-to-peer network 108 may then transfer the received broadcast channels to the other peers within the peer-to-peer network 108.

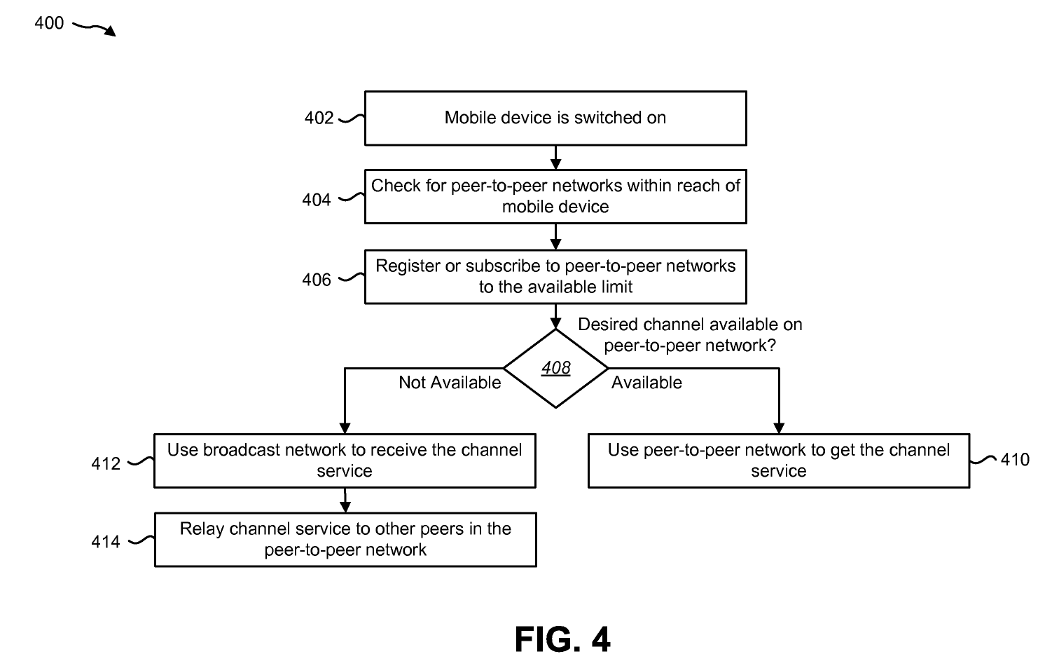

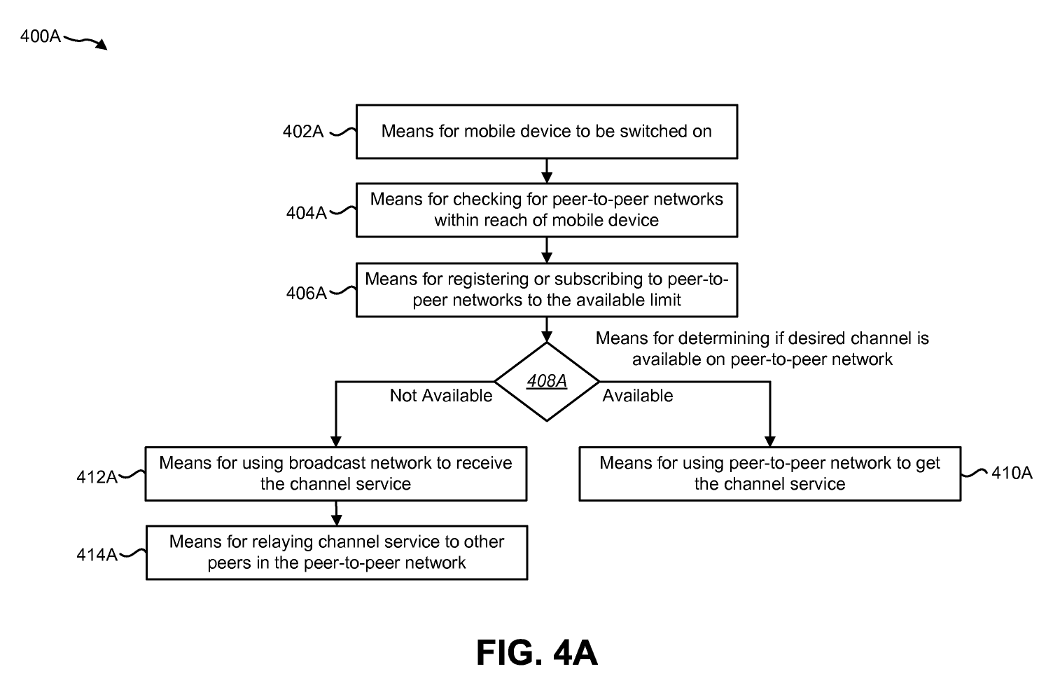

FIG. 4 is a flow diagram illustrating a method 400 for registering a mobile device 102 with a peer-to-peer network 108. The mobile device 102 may be switched 402 on. For example, the mobile device 102 may be powered up and/or the wireless capability of the mobile device 102 may be switched on or enabled. The mobile device 102 may then check 404 for or detect peer-to-peer networks 108 within reach of the mobile device 102. The mobile device may then register 406 or subscribe to the peer-to-peer networks 108 available, up to the available limit. The available limit may be a preset limit on the number of peer-to-peer networks 108 that a mobile device 102 may subscribe to.

The mobile device 102 may then determine 408 whether the desired channel for the mobile device 102 is available on the peer-to-peer network 108 subscribed to. For example, the mobile device 102 may determine whether a specific broadcast channel (the desired channel) is currently being received by one or more other mobile devices 102 within the peer-to-peer network 108. If the desired channel is available on the peer-to-peer network 108, the mobile device 102 may use 410 the peer-to-peer network 108 to get the channel service. If the desired channel is not available on the peer-to-peer network 108, the mobile device 102 may use 412 the broadcast network 106 to receive the channel service for the desired broadcast channel. The mobile device 102 may then relay 414 the channel service to the other peers within the peer-to-peer network 108 that have requested the channel.

The method 400 of FIG. 4 described above may be performed by various hardware and/or software component(s) and/or module(s) corresponding to the means-plus-function blocks 400A illustrated in FIG. 4A. In other words, blocks 402 through 414 illustrated in FIG. 4 correspond to means-plus-function blocks 402A through 414A illustrated in FIG. 4A.

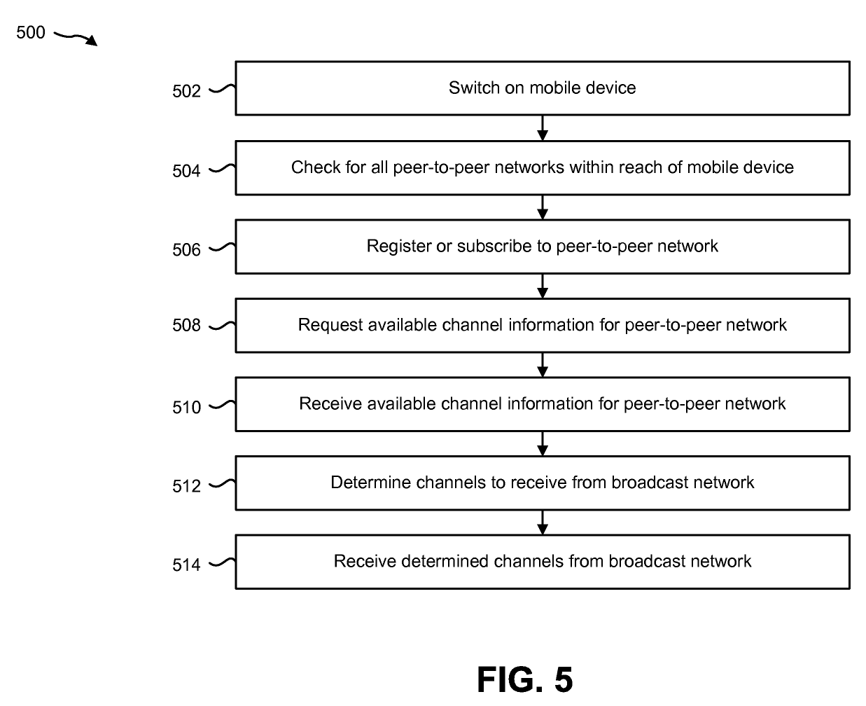

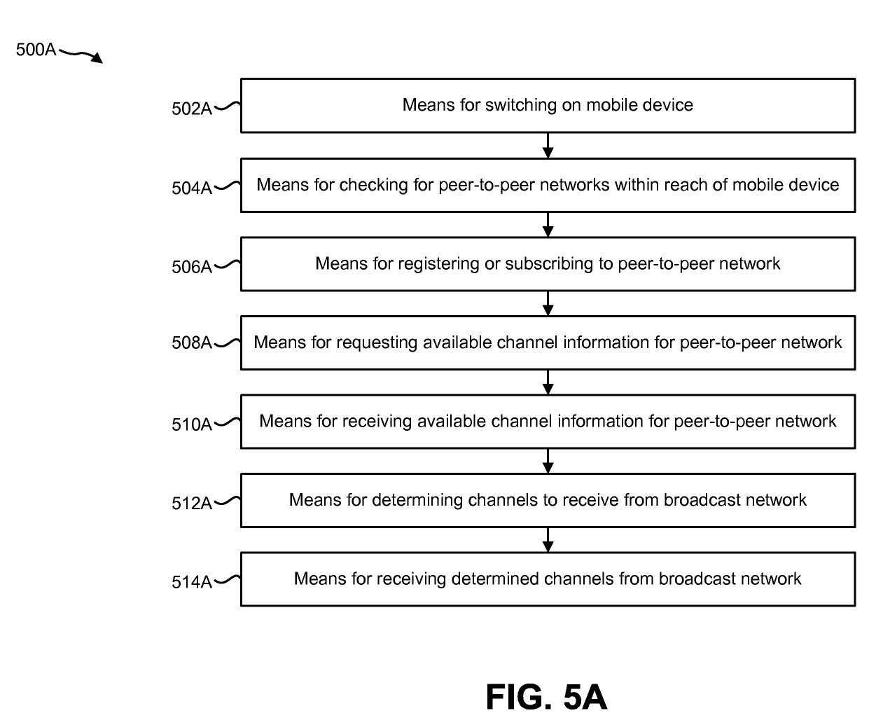

FIG. 5 is a flow diagram illustrating a method 500 for registering with a peer-to-peer network 108 to receive broadcast channels using cooperative MIMO. The mobile device 102 may be switched 502 on (e.g., powered up and/or the wireless capability switched on or enabled). The mobile device 102 may then check 504 for or detect the peer-to-peer networks 108 within reach of the mobile device 102. The mobile device 102 may register 506 or subscribe to a peer-to-peer network 108. The mobile device 102 may request 508 available channel information for the peer-to-peer network 108. For example, the mobile device 102 may request information of which channels are currently being received by the peer-to-peer network 108. The mobile device 102 may receive 510 available channel information for the peer-to-peer network 108.

Based on the received available channel information for the peer-to-peer network 108, the mobile device 102 may determine 512 one or more channels to receive from the broadcast network 106. For example, the mobile device 102 may determine which broadcast channels are not available for the peer-to-peer network 108. As another example, the mobile device 102 may determine which broadcast channels can be received by the mobile device 102 from the broadcast network 106 to reduce the burden on other mobile devices 102 within the peer-to-peer network 108 and/or improve the signal quality of broadcast channels received by the peer-to-peer network 108. The mobile device 102 may then receive 514 the determined channels from the broadcast network 106.

The method 500 of FIG. 5 described above may be performed by various hardware and/or software component(s) and/or module(s) corresponding to the means-plus-function blocks 500A illustrated in FIG. 5A. In other words, blocks 502 through 514 illustrated in FIG. 5 correspond to means-plus-function blocks 502A through 514A illustrated in FIG. 5A.

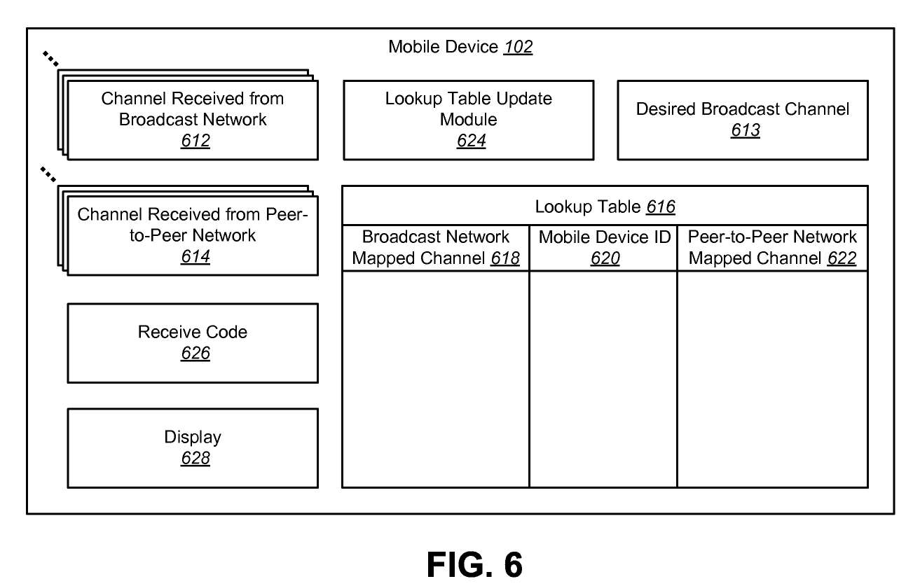

FIG. 6 is a block diagram illustrating some of the components of one configuration of a mobile device 602 for use in the present methods and apparatus. The mobile device 602 of FIG. 6 is one possible configuration of the mobile devices 102 shown in FIG. 1. The mobile device 602 may receive one or more channels 612 from the broadcast network 106. The channels 612 received from the broadcast network 106 may be HDTV channels. The mobile device 602 may also receive one or more channels 614 from the peer-to-peer network 108. The channels 614 received from the peer-to-peer network 108 may be HDTV channels. The channels 614 received from the peer-to-peer network 108 may have enhanced signal quality. The mobile device 602 may receive all the channels 614 from the peer-to-peer network 108 that are currently received by the peer-to-peer network 108. For example, the mobile device 602 may receive all the channels 614 that are being received by any node within the peer-to-peer network 108. Alternatively, the mobile device 602 may only receive a desired broadcast channel 613 from the peer-to-peer network 108.

The mobile device 602 may include a receive code 626. The receive code 626 may be used by the mobile device 602 to receive only the channels 612 or portions of channels desired from the broadcast network 106, as opposed to receiving every channel transmitted over the broadcast network 106.

The mobile device 602 may include a lookup table 616. The lookup table 616 may map received channels 612 from the broadcast network 106 to peer-to-peer channels 614. For example, the lookup table 616 may be a table with the broadcast network mapped channel 618, the corresponding peer-to-peer network mapped channel 622, and the mobile device ID(s) 620 receiving the broadcast network mapped channel 618. The mobile device 602 may use the lookup table 616 to determine which peer-to-peer channel 614 corresponds to the desired broadcast channel 613. The lookup table 616 may translate the broadcast network mapped channel 618 number to the corresponding peer-to-peer network mapped channel number 622. The lookup table 616 may also translate the peer-to-peer network mapped channel 622 number to the corresponding broadcast network mapped channel 618 number. The mobile device 602 may also use the lookup table 616 to enhance the signal quality for a received channel. For example, the mobile device 602 may use the lookup table 616 to determine which peer-to-peer network mapped channels 622 correspond to the one or more received channels 612 from the broadcast network 106. The mobile device 602 may then use cooperative MIMO to improve the signal quality of the received broadcast channels 612.

Once a desired broadcast channel 613 received from the peer-to-peer network 108 has been decoded, the desired broadcast channel 613 may then be displayed to the mobile device 602 user using a display 628. The desired broadcast channel 613 may be displayed as a broadcast channel. In one configuration, the display 628 may be an HDTV video display.

The mobile device 602 may include a lookup table update module 624. The lookup table update module 624 may update the lookup table 616. For example, the lookup table update module 624 may update the lookup table 616 whenever a node is added to or deleted from the peer-to-peer network 108.

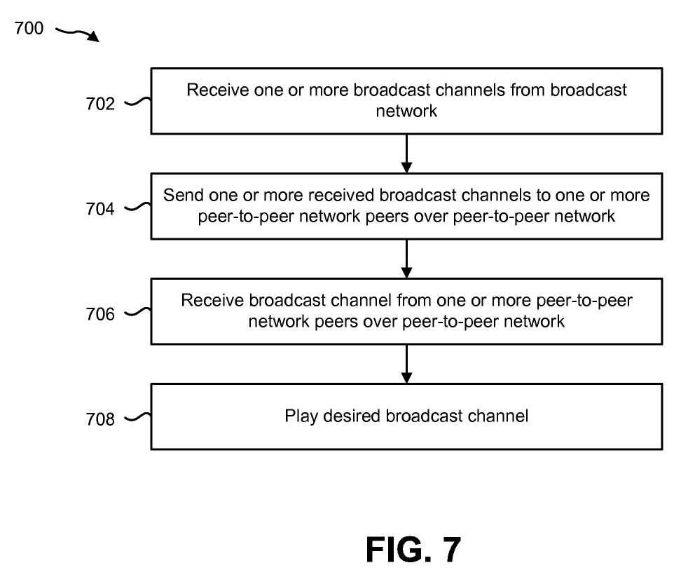

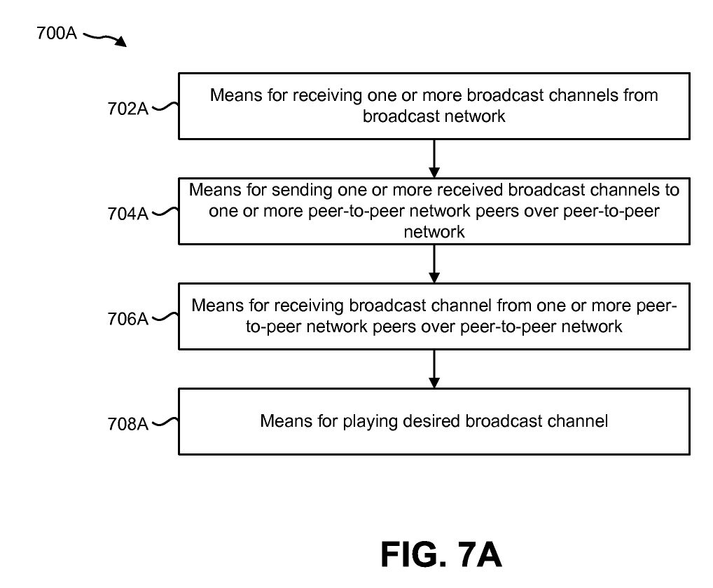

FIG. 7 is a flow diagram illustrating a method 700 for a hybrid peer-to-peer and broadcast HDTV network. A mobile device 102 may be part of both a broadcast network 106 and a peer-to-peer network 108. The mobile device 102 may receive 702 one or more broadcast channels 612 from the broadcast network 106. The mobile device 102 may then send 704 one or more of the received broadcast channels 612 to one or more peer-to-peer network 108 peers over a peer-to-peer network 108. If the mobile device 102 is registered with more than one peer-to-peer network 108, the mobile device 102 may send 704 the one or more received broadcast channels 612 to multiple peer-to-peer networks 108.

The mobile device 102 may receive 706 one or more broadcast channels from one or more peer-to-peer network 108 peers over the peer-to-peer network 108. For example, the mobile device may receive 706 a desired broadcast channel 613 from one or more peer-to-peer network 108 peers. The mobile device 102 may then play 708 the desired broadcast channel 613. For example, the mobile device 102 may play 708 the desired broadcast channel 613 on a display 628.

The method 700 of FIG. 7 described above may be performed by various hardware and/or software component(s) and/or module(s) corresponding to the means-plus-function blocks 700A illustrated in FIG. 7A. In other words, blocks 702 through 708 illustrated in FIG. 7 correspond to means-plus-function blocks 702A through 708A illustrated in FIG. 7A.

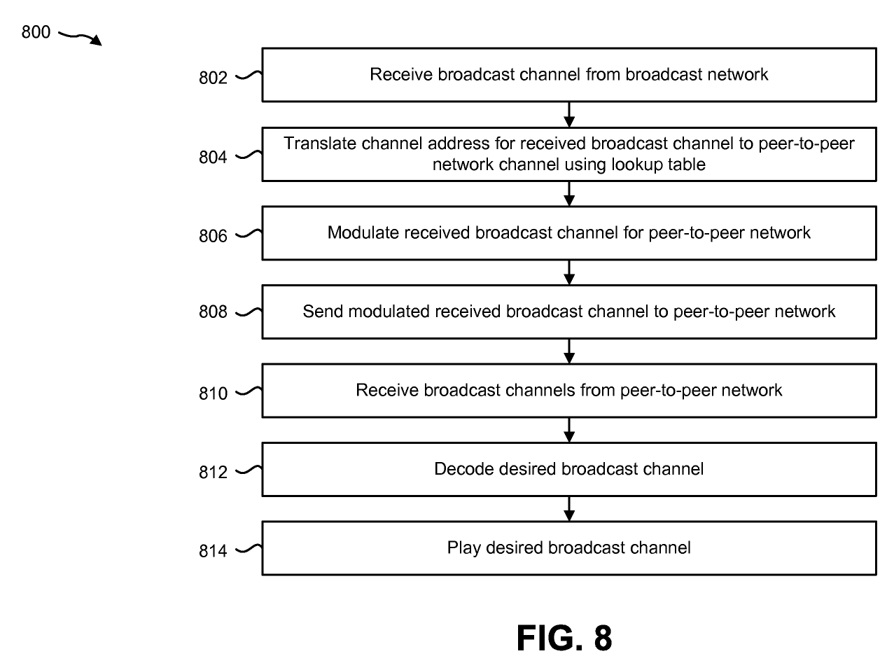

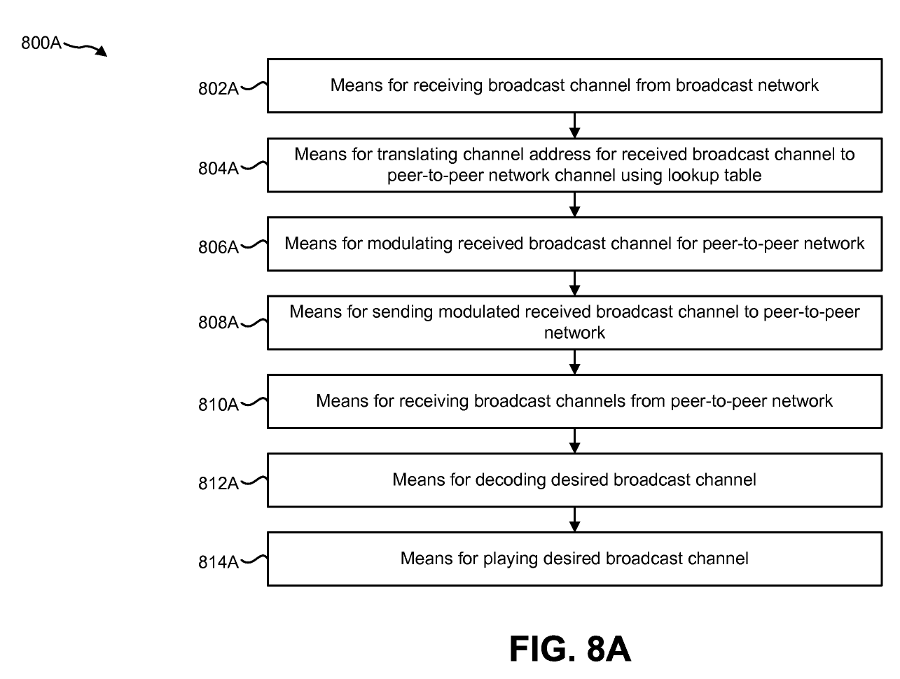

FIG. 8 is a flow diagram illustrating another method 800 for receiving and displaying HDTV channels in a hybrid peer-to-peer and broadcast network. A mobile device 102 may receive 802 a broadcast channel 612 from a broadcast network 106. The mobile device 102 may translate 804 the channel address for the received broadcast channel 612 to a peer-to-peer network channel 622 using a lookup table 624. The mobile device 102 may then modulate 806 the received broadcast channel 612 for the peer-to-peer network 108. The mobile device 102 may send 808 the modulated received broadcast channel 612 to the peer-to-peer network 108.

The mobile device 102 may receive 810 one or more broadcast channels 614 from the peer-to-peer network 108. For example, the mobile device 102 may receive 810 a desired broadcast channel 613 for display by the mobile device 102. The mobile device 102 may then decode 812 the desired broadcast channel 613. Once the mobile device 102 has decoded the desired broadcast channel 613, the mobile device 102 may play 814 the desired broadcast channel 613. For example, the mobile device 102 may play 814 the desired broadcast channel 613 by displaying the desired broadcast channel 613 on a display 628.

The method 800 of FIG. 8 described above may be performed by various hardware and/or software component(s) and/or module(s) corresponding to the means-plus-function blocks 800A illustrated in FIG. 8A. In other words, blocks 802 through 814 illustrated in FIG. 8 correspond to means-plus-function blocks 802A through 814A illustrated in FIG. 8A.

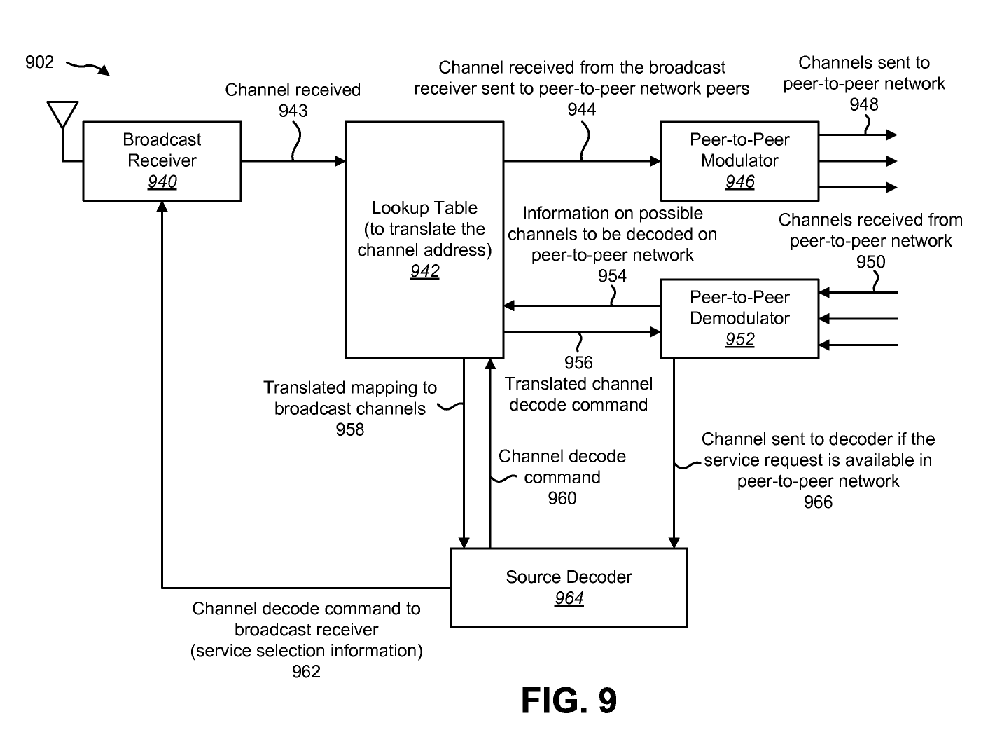

FIG. 9 is a block diagram illustrating the architecture of one configuration of a mobile device 902 which supports both a broadcast network 106 and a peer-to-peer network 108 on the same device. The mobile device 902 may include a broadcast receiver 940. The broadcast receiver 940 may receive one or more broadcast channels 612 from the broadcast network 106. The broadcast channels 612 may be MIMO modulated such that a receive code 626 is necessary to decode the appropriate portion of the received broadcast channel 612. The broadcast receiver 940 may receive a channel decode command 962 from a source decoder 964. The channel decode command 962 may allow the broadcast receiver 940 to decode one or more broadcast channels 612. The decoded received broadcast channels 943 may be translated to peer-to-peer network 108 channels by a lookup table 942. The lookup table 942 may send 944 the translated broadcast channels 612 to a peer-to-peer modulator 946.

Once the translated broadcast channels 612 have been modulated for the peer-to-peer network 108, the translated broadcast channels 612 may be sent 948 to other mobile devices 102 within the peer-to-peer network 108. For example, the translated broadcast channels 612 may be sent 948 directly to other mobile devices 102 within the peer-to-peer network 108. Alternatively, the translated broadcast channels 612 may be sent 948 through an access point in the peer-to-peer network 108 to other mobile devices 102 within the peer-to-peer network 108.

The mobile device 902 may receive 950 one or more peer-to-peer channels 614 from the peer-to-peer network 108. For example, the mobile device 902 may receive 950 one or more peer-to-peer channels 614 directly from one or more peers within the peer-to-peer network 108. Alternatively, the mobile device 902 may receive 950 one or more peer-to-peer channels 614 from one or more peers within the peer-to-peer network 108 indirectly through an access point in the peer-to-peer network 108. As discussed above in relation to FIG. 6, a peer-to-peer channel 614 is a broadcast channel 612 where the channel address for the broadcast channel 612 has been translated for the peer-to-peer network 108.

The one or more peer-to-peer channels 614 received from the peer-to-peer network 108 may be demodulated by a peer-to-peer demodulator 952. The channel information may be sent 954 to the lookup table 942. For example, the peer-to-peer channel number may be sent 954 to the lookup table 942. The channel address for the one or more peer-to-peer channels 614 may then be translated back to the channel address for the broadcast channel 614 using the lookup table 942. A translated channel decode command may be sent 956 to the peer-to-peer demodulator 952 by the lookup table 942.

The lookup table 942 may send 958 a broadcast channel number to the source decoder 964. The peer-to-peer demodulator 952 may send 966 the physical channel to the source decoder 964. The physical channel may be sent to the source decoder 964 after channel detection, demodulation using an inverse fast Fourier transform (IFFT), deinterleaving, and error correction. The source decoder 964 may generate the channel number from Electronic Programming Guide (EPG) action on a user interface, such as the MediaFLO User Interface. Examples of EPG action include, but are not limited to, selecting a TV channel and changing the TV channel to switch on a mobile TV. The source decoder 964 may send 960 a channel decode command with addition controls for decoding and the channel number to be decoded to the lookup table. The addition controls may be a “Decode command” that may be a 1-bit pulse sent as a command.

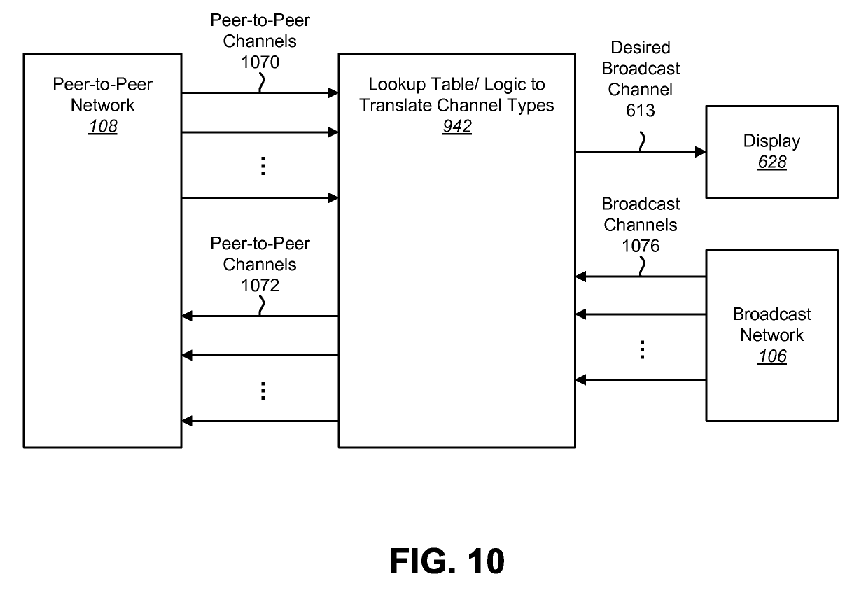

FIG. 10 is a block diagram illustrating the functionality of one configuration of a lookup table 1042 on a mobile device 102. The lookup table 1042 may receive one or more broadcast channels 1076 from a broadcast network 106. The lookup table 1042 may translate the one or more broadcast channels 1076 received into peer-to-peer channels 1072. In other words, the lookup table 1042 may map the broadcast channels 1076 to peer-to-peer channels 1072. The peer-to-peer channels 1072 may then be sent to other peers within a peer-to-peer network 108.

The lookup table 1042 may receive one or more peer-to-peer channels 1070 from the peer-to-peer network 108. The lookup table 1042 may translate the peer-to-peer channels 1070 back into broadcast channels 1076. A desired broadcast channel 613 may then be output to a display 628 on a mobile device 102.

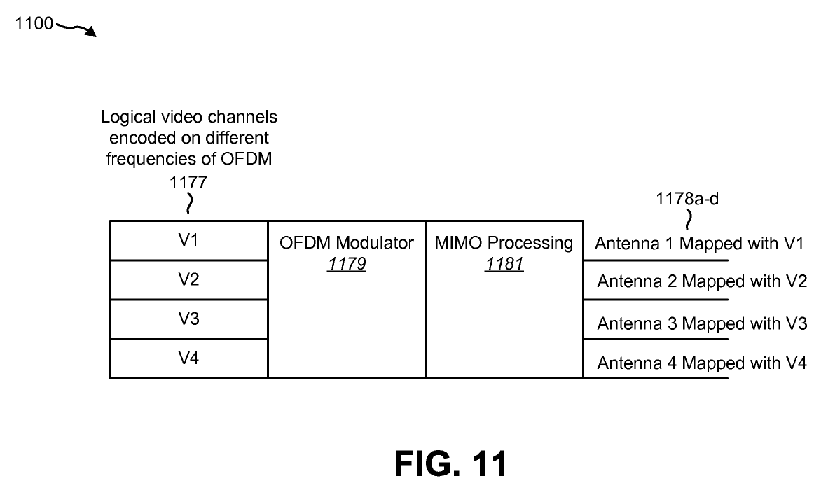

FIG. 11 is a block diagram illustrating a spatial multiplexing MIMO configuration 1100. One or more logical video streams or channels 1177 may each be encoded on different frequencies of OFDM through use of an OFDM modulator 1179. The logical video channels may then each be mapped to a different antenna through MIMO processing 1181. Each antenna 1178a-1178d may then broadcast the mapped logical video stream. Both MediaFLO and DVBH may use MIMO for spatial multiplexing. The use of spatial multiplexing may increase the number of channels that are mapped. Spatial multiplexing may work with both a single frequency network (SFN) and a multi frequency network (MFN). In an SFN, several transmitters may simultaneously send the same signal using the same frequency channel. In contrast, within an MFN, multiple radio frequencies may be used to transmit a logical video stream.

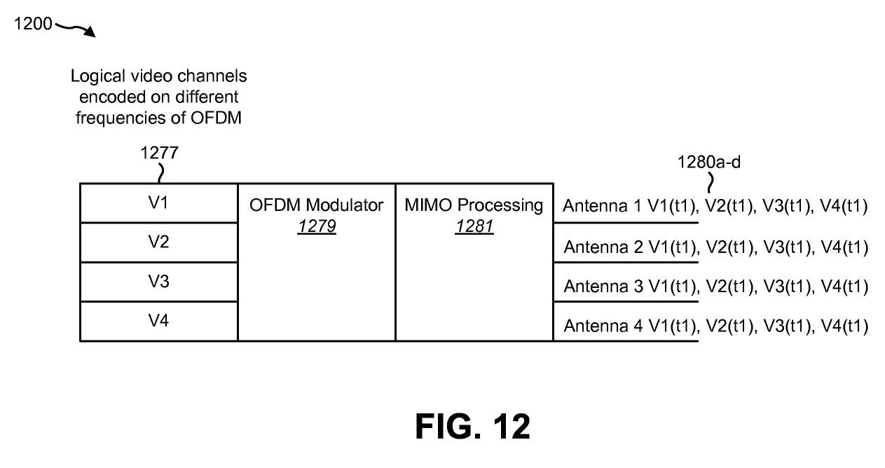

FIG. 12 is a block diagram illustrating a diversity mapping MIMO configuration 1200. One or more logical video streams 1277 may each be encoded on different frequencies of OFDM by an OFDM modulator 1279. Each logical video channel may then be mapped to each antenna through MIMO processing 1281. A portion of each logical video channel may be mapped to each antenna through the MIMO processing 1281 to add diversity at interleavers. Alternatively, a particular group of channels may be fixed to each antenna, thereby providing spatial diversity. Each antenna 1280a-1280d may then broadcast the mapped portions of each logical video stream. Both MediaFLO and DVBH may use MIMO for diversity mapping of video channels to antennas. Diversity mapping of video channels may increase the reliability of a video transmission. Diversity mapping may be compatible with an MFN. Diversity mapping MIMO may also be used with an SFN if all transmitters use the same MIMO schemes and are in sync. Because the same carrier may be used to send the same type of channels from different sources, frequency diversity is independent of spatial diversity techniques such as MIMO.

FIGS. 11 and 12 are examples of mapping the video streams to MIMO. Alternatively, the video streams may be mapped using Diagonal-Bell Labs' Layered Space-Time (D-BLAST), Vertical-Bell Labs' Layered Space-Time (V-BLAST), block diagonalization, etc.

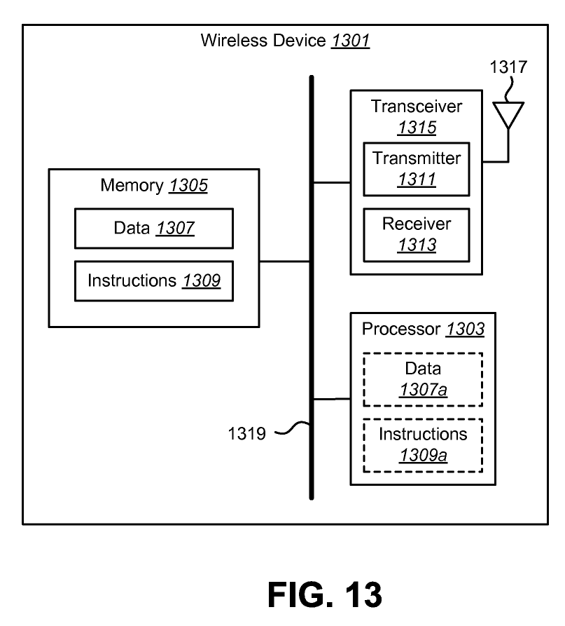

FIG. 13 illustrates certain components that may be included within a wireless device 1301. The wireless device 1301 may be a mobile device 102 or a base station.

The wireless device 1301 includes a processor 1303. The processor 1303 may be a general purpose single- or multi-chip microprocessor (e.g., an ARM), a special purpose microprocessor (e.g., a digital signal processor (DSP)), a microcontroller, a programmable gate array, etc. The processor 1303 may be referred to as a central processing unit (CPU). Although just a single processor 1303 is shown in the wireless device 1301 of FIG. 13, in an alternative configuration, a combination of processors (e.g., an ARM and DSP) could be used.

The wireless device 1301 also includes memory 1305. The memory 1305 may be any electronic component capable of storing electronic information. The memory 1305 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 1307 and instructions 1309 may be stored in the memory 1305. The instructions 1309 may be executable by the processor 1303 to implement the methods disclosed herein. Executing the instructions 1309 may involve the use of the data 1307 that is stored in the memory 1305. When the processor 1303 executes the instructions 1307, various portions of the instructions 1307a may be loaded onto the processor 1303, and various pieces of data 1309a may be loaded onto the processor 1303.

The wireless device 1301 may also include a transmitter 1311 and a receiver 1313 to allow transmission and reception of signals to and from the wireless device 1301. The transmitter 1311 and receiver 1313 may be collectively referred to as a transceiver 1315. An antenna 1317 may be electrically coupled to the transceiver 1315. The wireless device 1301 may also include (not shown) multiple transmitters, multiple receivers, multiple transceivers and/or multiple antenna.

The various components of the wireless device 1301 may be coupled together by one or more buses, which may include a power bus, a control signal bus, a status signal bus, a data bus, etc. For the sake of clarity, the various buses are illustrated in FIG. 13 as a bus system 1319.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The terms “computer-readable medium” or “computer-program product” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 4, 5, 7 and 8, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for obtaining a desired broadcast channel, the method comprising:
receiving a broadcast channel from a broadcast network;
sending the received broadcast channel to at least one peer-to-peer network peer over a peer-to-peer network;
receiving a desired broadcast channel from at least one peer-to-peer network peer over the peer-to-peer network; and
playing the desired broadcast channel.

2. The method of claim 1, wherein the broadcast channel is a high definition television (HDTV) channel.

3. The method of claim 1, further comprising translating a channel address for a received broadcast channel to a peer-to-peer network channel using a lookup table.

4. The method of claim 1, further comprising decoding the received broadcast channel using a lookup table.

5. The method of claim 1, wherein the received broadcast channel from a broadcast network is modulated using cooperative multiple input multiple output (MIMO).

6. The method of claim 5, further comprising cooperating with a peer of the peer-to-peer network to enhance the signal quality of the received broadcast channel.

7. The method of claim 1, further comprising using a receive code to receive only part of a broadcast transmission from the broadcast network, wherein the broadcast transmission includes one or more broadcast channels.

8. The method of claim 1, further comprising registering with a peer-to-peer network to receive broadcast channels, wherein the method is performed by a mobile device, and wherein registering with a peer-to-peer network comprises:
detecting one or more peer-to-peer networks within reach of the mobile device;
registering with a peer-to-peer network within reach of the mobile device;
requesting available channel information for the peer-to-peer network that the mobile device is registered with;
receiving the available channel information for the peer-to-peer network that the mobile device is registered with; and
determining a broadcast channel to receive from a broadcast network.

9. The method of claim 3, further comprising updating the lookup table when a new peer is added to the peer-to-peer network.

10. The method of claim 3, further comprising updating the lookup table when a peer is removed from the peer-to-peer network.

11. The method of claim 2, wherein playing the desired broadcast channel comprises displaying the desired broadcast channel on a high definition television (HDTV) video display.

12. The method of claim 1, wherein receiving a broadcast channel further comprises receiving a plurality of broadcast channels from the broadcast network.

13. The method of claim 1, wherein sending the received broadcast channel further comprises sending the received broadcast channel to a plurality of peer-to-peer network peers over the peer-to-peer network.

14. The method of claim 1, wherein receiving the desired broadcast channel further comprises receiving the desired broadcast channel from a plurality of peer-to-peer network peers.

15. A wireless device configured for operation in a hybrid broadcast and peer-to-peer network, comprising:
a processor;
memory in electronic communication with the processor;
instructions stored in the memory, the instructions being executable by the processor to:
receive a broadcast channel from a broadcast network;
send the received broadcast channel to at least one peer-to-peer network peer over a peer-to-peer network;
receive a desired broadcast channel from at least one peer-to-peer network peer over the peer-to-peer network; and
play the desired broadcast channel.

16. The wireless device of claim 15, wherein the broadcast channel is a high definition television (HDTV) channel.

17. The wireless device of claim 15, wherein the instructions are further executable to translate a channel address for a received broadcast channel to a peer-to-peer network channel using a lookup table.

18. The wireless device of claim 15, wherein the instructions are further executable to decode the received broadcast channel using a lookup table.

19. The wireless device of claim 15, wherein the received broadcast channel from a broadcast network is modulated using cooperative multiple input multiple output (MIMO).

20. The wireless device of claim 19, wherein the instructions are further executable to cooperate with a peer of the peer-to-peer network to enhance the signal quality of the received broadcast channel.

21. The wireless device of claim 15, wherein the instructions are further executable to use a receive code to receive only part of a broadcast transmission from the broadcast network, wherein the broadcast transmission includes one or more broadcast channels.

22. The wireless device of claim 15, wherein the instructions are further executable to register with a peer-to-peer network to receive broadcast channels, and wherein registering with a peer-to-peer network comprises:
detecting one or more peer-to-peer networks within reach of the wireless device;
registering with a peer-to-peer network within reach of the wireless device;
requesting available channel information for the peer-to-peer network that the wireless device is registered with;
receiving available channel information for the peer-to-peer network that the wireless device is registered with; and
determining a broadcast channel to receive from a broadcast network.

23. The wireless device of claim 17, wherein the instructions are further executable to update the lookup table when a new peer is added to the peer-to-peer network.

24. The wireless device of claim 17, wherein the instructions are further executable to update the lookup table when a peer is removed from the peer-to-peer network.

25. The wireless device of claim 16, wherein playing the desired broadcast channel comprises displaying the desired broadcast channel on a high definition television (HDTV) video display.

26. The wireless device of claim 15, wherein the instructions for receiving a broadcast channel are further executable to receive a plurality of broadcast channels from the broadcast network.

27. The wireless device of claim 15, wherein the instructions for sending the received broadcast channel are further executable to send the received broadcast channel to a plurality of peer-to-peer network peers over the peer-to-peer network.

28. The wireless device of claim 15, wherein the instructions for receiving the desired broadcast channel are further executable to receive the desired broadcast channel from a plurality of peer-to-peer network peers.

29. The wireless device of claim 15, wherein the wireless device is a modem.

30. The wireless device of claim 15, wherein the wireless device is a modem capable of communicating concurrently with a broadcast network and a peer-to-peer network.

31. A wireless device configured for operation in a hybrid broadcast and peer-to-peer network, comprising:
means for receiving a broadcast channel from a broadcast network;
means for sending the received broadcast channel to at least one peer-to-peer network peer over a peer-to-peer network;
means for receiving a desired broadcast channel from at least one peer-to-peer network peer over the peer-to-peer network; and
means for playing the desired broadcast channel.

32. A computer-program product for a wireless device configured for operation in a hybrid broadcast and peer-to-peer network, the computer-program product comprising a computer-readable medium having instructions thereon, the instructions comprising:
code for receiving a broadcast channel from a broadcast network;
code for sending the received broadcast channel to at least one peer-to-peer network peer over a peer-to-peer network;
code for receiving a desired broadcast channel from at least one peer-to-peer network peer over the peer-to-peer network; and
code for playing the desired broadcast channel.

33. A wireless communication system comprising:
a broadcast network, wherein the broadcast network comprises at least one broadcast transmitter and at least two receiving mobile devices, and wherein the broadcast transmitter transmits a broadcast transmission to at least one of the receiving mobile devices; and
a peer-to-peer network, wherein the peer-to-peer network comprises the at least two receiving mobile devices, and wherein at least one of the receiving mobile devices receives the broadcast transmission from the broadcast transmitter, and wherein the receiving mobile device that receives the broadcast transmission shares the broadcast transmission with other mobile devices within the peer-to-peer network.

34. The wireless communication system of claim 33, wherein each mobile device in the peer-to-peer network acts as a receiving antenna in a virtual multiple input multiple output (MIMO) receiver.

35. The wireless communication system of claim 33, wherein each mobile device in the peer-to-peer network cooperates to decode the broadcast transmission.

36. The wireless communication system of claim 33, wherein the broadcast transmission is a high definition television (HDTV) channel.

37. The wireless communication system of claim 33, wherein the at least two receiving mobile devices decode the received broadcast transmission using a lookup table.

38. The wireless communication system of claim 37, wherein the lookup table is updated when additional receiving mobile devices are added to the peer-to-peer network.
